(19) United States
(12) Patent Application Publication
(10) Pub. No.: US 2020/0248050 A1
(43) Pub. Date: Aug. 6, 2020

(54) Two-Component Structural Adhesives

(71) Applicant: PPG Industries Ohio, Inc., Cleveland, OH (US)

(72) Inventors: Masayuki Nakajima, Wexford, PA (US); Kar Tean Tan, Wexford, PA (US); Jonathan P. Breon, Pittsburgh, PA (US); Hongying Zhou, Allison Park, PA (US); Allison G. Condie, Valencia, PA (US); Fanghui Wu, Pittsburgh, PA (US)

(73) Assignee: PPG Industries Ohio, Inc., Cleveland, OH (US)

(21) Appl. No.: 16/649,511

(22) PCT Filed: Sep. 20, 2018
(86) PCT No.: PCT/US2018/051972

§ 371 Date: Mar. 20, 2020

Related U.S. Application Data
(60) Provisional application No. 62/561,014, filed on Sep. 20, 2017.

(51) Int. Cl. C09J 163/00; C09J 11/08; C09J 5/00

(52) U.S. Cl. CPC C09J 163/00; C09J 11/08; C09J 2409/00; C09J 2205/31; C09J 2463/00; C09J 5/00

(57) ABSTRACT

The present invention is directed toward an adhesive composition comprising: a first component; and a second component that chemically reacts with the first component, the second component comprising: a polythiol curing agent; and an alkanolamine. Also disclosed are methods of forming a bond between two substrates and adhesive bonds.

### CROSS-REFERENCE TO RELATED APPLICATION

This application claims priority to U.S. Provisional Patent Application Ser. No. 62/561,014, filed on Sep. 20, 2017 and entitled “Two-Component Structural Adhesive,” incorporated in its entirety herein by reference.

### FIELD OF THE INVENTION

The present invention relates to adhesive compositions and more particularly to 2K adhesive compositions.

### BACKGROUND OF THE INVENTION

Adhesives are utilized in a wide variety of applications to bond together two or more substrate materials. For example, adhesives may be used for bonding together wind turbine blades or bonding together automotive structural components.

The present invention is directed towards two-component (2K) adhesive compositions that provide sufficient bond strength, are easy to apply, and, where applicable, have sufficiently long pot lives for use in bonding together substrate materials.

### SUMMARY OF THE INVENTION

An aspect of the invention provides an adhesive composition comprising: a first component; and a second component that chemically reacts with the first component, the second component comprising: a polythiol curing agent; and an alkanolamine.

Another aspect of the invention provides a method for forming a bond between two substrates comprising: applying the adhesive composition of the present invention to a first substrate; contacting a second substrate to the adhesive composition such that the adhesive composition is located between the first substrate and the second substrate; and curing the adhesive composition by a two-step curing process.

A further aspect of the invention provides an adhesive bond formed between one or more substrates by the adhesive composition of the present invention in an at least partially cured state.

### DETAILED DESCRIPTION OF THE INVENTION

The present invention is directed to an adhesive composition comprising a first component and a second component that chemically reacts with the first component, the second component comprising a polythiol curing agent and an alkanolamine. The adhesive composition may be a structural adhesive composition. The adhesive composition may be used to bond together two substrate materials for a wide variety of potential applications in which the bond between the substrate materials may provide particular mechanical properties related to elongation, tensile strength, lap shear strength, T-peel strength, modulus, wedge impact, or impact peel strength. The adhesive is applied to either one or both of the materials being bonded. The pieces are aligned and pressure and spacers may be added to control bond thickness.

According to the present invention, the adhesive composition comprises a two-component (“2K”) adhesive composition. As used herein, a “two-component adhesive composition” (or “2K adhesive composition”) refers to a composition in which at least a portion of the reactive components readily react and cure without activation from an external energy source, such as at ambient or slightly thermal conditions, when mixed. One of skill in the art understands that the two components of the adhesive composition are stored separately from each other and mixed just prior to application of the adhesive composition. The 2K adhesive compositions of the present invention may be subjected to a two-step curing process wherein (1) at least a portion of the first component and the second component chemically react when mixed to partially cure the adhesive composition without activation from an external energy source, followed by (2) the application of an external energy source to the adhesive composition to further cure the adhesive composition. As further defined herein, ambient conditions generally refer to room temperature (about 23° C.) and humidity conditions (e.g., about 50%) or temperature and humidity conditions that are typically found in the area in which the adhesive is being applied to a substrate, while slightly thermal conditions are temperatures that are slightly above ambient temperature, such as, e.g., 10% greater, but are generally below the curing temperature for the second-step of the two-step curing process.

According to the present invention, the adhesive composition comprises a first component. The first component comprises one or more epoxy-containing compounds.

Suitable epoxy-containing compounds that may be used in the first component may comprise polyepoxides. Suitable polyepoxides include polyglycidyl ethers of Bisphenol A, such as Epon® 828 and 1001 epoxy resins, and Bisphenol F diepoxides, such as Epon® 862, which are commercially available from Hexion Specialty Chemicals, Inc. Other suitable polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides that are derived from the epoxidation of an olefinically unsaturated nonaromatic cyclic compound, polyepoxides containing oxyalkylene groups in the epoxy molecule, and epoxy novolac resins. Still other suitable epoxy-containing compounds include epoxidized Bisphenol A novolacs, epoxidized phenolic novolacs, epoxidized cresylic novolac, and triglycidyl p-aminophenol bismaleimide. The epoxy-containing compound may also comprise an epoxy-dimer acid adduct. The epoxy-dimer acid adduct may be formed as the reaction product of reactants comprising a diepoxide compound (such as a polyglycidyl ether of Bisphenol A) and a dimer acid (such as a C36 dimer acid). The epoxy-containing compound may also comprise a carboxyl-terminated butadiene-acrylonitrile copolymer modified epoxy-containing compound. The epoxy-containing compound may also comprise epoxidized castor oil.

According to the present invention, the epoxy-containing compound may comprise an epoxy-adduct. The first component may comprise one or more epoxy-adducts. As used herein, the term “epoxy-adduct” refers to a reaction product comprising the residue of an epoxy compound and at least one other compound that does not include an epoxide functional group. For example, the epoxy-adduct may comprise the reaction product of reactants comprising: (1) an epoxy compound, a polyol, and an anhydride; (2) an epoxy compound, a polyol, and a diacid; or (3) an epoxy compound, a polyol, an anhydride, and a diacid.

According to the present invention, the epoxy compound used to form the epoxy-adduct may comprise any of the epoxy-containing compounds listed above that may be included in the first component.

According to the present invention, the polyol used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. The polyol may also be based on a polyester chain derived from ring opening polymerization of caprolactone (referred to as polycaprolactone-based polyols hereinafter). Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the diacids and anhydrides.

The polyol may comprise a polycaprolactone-based polyol. The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

According to the present invention, the anhydride used to form the epoxy-adduct may comprise any suitable acid anhydride known in the art. For example, the anhydride may comprise hexahydrophthalic anhydride and its derivatives (e.g., methyl hexahydrophthalic anhydride); phthalic anhydride and its derivatives (e.g., methyl phthalic anhydride); maleic anhydride; succinic anhydride; trimelletic anhydride; pyromelletic dianhydride (PMDA); 3,3′,4,4′-oxydiphthalic dianhydride (ODPA); 3,3′,4,4′-benzopherone tetracarboxylic dianhydride (BTDA); and 4,4′-diphthalic (hexafluoroisopropylidene) anhydride (6FDA).

According to the present invention, the diacid used to form the epoxy-adduct may comprise any suitable diacid known in the art. For example, the diacids may comprise phthalic acid and its derivates (e.g., methyl phthalic acid), hexahydrophthalic acid and its derivatives (e.g., methyl hexahydrophthalic acid), maleic acid, succinic acid, adipic acid, and the like.

According to the present invention, the epoxy-adduct may comprise a diol, a monoanhydride or a diacid, and a diepoxy compound, wherein the mole ratio of diol, monoanhydride (or diacid), and diepoxy compounds in the epoxy-adduct may vary from 0.5:0.8:1.0 to 0.5:1.0:6.0.

According to the present invention, the epoxy-adduct may comprise a triol, a monoanhydride or a diacid, and a diepoxy compound, wherein the mole ratio of triol, monoanhydride (or diacid), and diepoxy compounds in the epoxy-adduct may vary from 0.5:0.8:1.0 to 0.5:1.0:6.0.

According to the present invention, the epoxy-adduct may comprise a tetraol, a monoanhydride or a diacid, and a diepoxy compound, wherein the mole ratio of tetraol, monoanhydride (or diacid), and diepoxy compounds in the epoxy-adduct may vary from 0.5:0.8:1.0 to 0.5:1.0:6.0.

The epoxy-adducts, when used, may be present in the first component of the adhesive composition in an amount of at least 0.5% by weight, based on the total weight of the first component, such as at least 3% by weight, such as at least 9% by weight, such as at least 12% by weight, and may be present in an amount of no more than 50% by weight, such as no more than 40% by weight, such as no more than 35% by weight, such as no more than 28% by weight. The epoxy adducts may be present in the first component in an amount of 0.5% to 50% by weight, based on the total weight of the first component, such as 3% to 40% by weight, such as 9% to 35% by weight, such as 12% to 28% by weight.

According to the present invention, the adhesive composition further comprises a second component that chemically reacts with the first component.

According to the present invention, the second component comprises a polythiol curing agent. As used herein, a “polythiol curing agent” refers to a chemical compound having at least two thiol functional groups (—SH) and may be used to “cure” the adhesive composition by reacting with the epoxy-containing compound of the first component to form a polymeric matrix upon combining the first and second components of the adhesive composition. As used herein, the term “cure”, “cured” or similar terms, as used in connection with the adhesive composition described herein, means that at least a portion of the components that form the adhesive composition are crosslinked to form an adhesive layer or bond. Additionally, curing of the adhesive composition refers to subjecting said composition to curing conditions leading to the reaction of the reactive functional groups of the components of the adhesive composition, and resulting in the crosslinking of at least a portion of the components of the composition. The adhesive composition may be subjected to curing conditions until it is at least partially cured. As used herein, the term “at least partially cured” means subjecting the adhesive composition to conditions (referred to as “curing conditions”) to form an adhesive layer or bond, wherein reaction of at least a portion of the reactive groups of the components of the adhesive composition occurs. As will be discussed in more detail below, the curing conditions used to cure the adhesive composition may comprise a two-step curing process. The “green strength” of the adhesive bond following the first-step of the two-step curing process may have a lap shear strength of greater than 1 MPa, as determined according to ASTM D1002-10 by using an Instron 5567 machine in tensile mode with a pull rate of 1.3 mm per minute. The green strength of the adhesive bond may be reached after allowing the adhesive composition to cure at ambient conditions for about 5 hours, such as about 1 hour, such as about 0.5 hour, such as about 0.3 hour. The adhesive composition may also be subjected to curing conditions such that a substantially complete cure is attained and wherein further curing results in no significant further improvement in the adhesive properties such as, for example, lap shear strength or T-peel strength. An adhesive will be considered to be “cured” after the two-step curing process when the adhesive bond has a lap shear strength of greater than 5 MPa, as determined according to ASTM D1002-10 by using an Instron 5567 machine in tensile mode with a pull rate of 1.3 mm per minute.

The polythiol curing agent may comprise a compound comprising at least two thiol functional groups. The polythiol curing agent may comprise a dithiol, trithiol, tetrathiol, pentathiol, hexathiol or higher functional polythiol compound. The polythiol curing agent may comprise a dithiol compound including 3,6-dioxa-1,8-octanedithiol (DMDO), 3-oxa-1,5-pentanedithiol, 1,2-ethanedithiol, 1,3-propanedithiol, 1,2-propanedithiol, 1,4-butanedithiol, 1,3-butanedithiol, 2,3-butanedithiol, 1,5-pentanedithiol, 1,3-pentanedithiol, 1,6-hexanedithiol, 1,3-dithio-3-methylbutane, ethylcyclohexyldithiol (ECHDT), methylcyclohexyldithiol, methyl-substituted dimercaptodiethyl sulfide, dimethyl-substituted dimercaptodiethyl sulfide, 2,3-dimercapto-1-propanol, bis-(4-mercaptomethylphenyl) ether, 2,2′-thiodiethanethiol, and glycol dimercaptoacetate (commercially available as THIOCURE® GDMA from BRUNO BOCK Chemische Fabrik GmbH & Co. KG). The polythiol curing agent may comprise a trithiol compound including trimethylpropane trimercaptoacetate (commercially available as THIOCURE® TMPMA from BRUNO BOCK Chemische Fabrik GmbH & Co. KG), trimethylopropane tris-3-mercaptopropionate (commercially available as THIOCURE® TMPMP from BRUNO BOCK Chemische Fabrik GmbH & Co. KG), ethoxylated trimethylpropane tris-3-mercaptopropionate polymer (commercially available as THIOCURE® ETTMP from BRUNO BOCK Chemische Fabrik GmbH & Co. KG), tris[2-(3-mercaptopropionyloxy)ethyl]isocyanurate (commercially available as THIOCURE® TEMPIC from BRUNO BOCK Chemische Fabrik GmbH & Co. KG). The polythiol curing agent may comprise a tetrathiol compound including pentaerythritol tetramercaptoacetate (commercially available as THIOCURE® PETMA from BRUNO BOCK Chemische Fabrik GmbH & Co. KG), pentaerythritol tetra-3-mercaptopropionate (commercially available as THIOCURE® PETMP from BRUNO BOCK Chemische Fabrik GmbH & Co. KG), and polycaprolactone tetra(3-mercaptopropionate) (commercially available as THIOCURE® PCL4MP 1350 from BRUNO BOCK Chemische Fabrik GmbH & Co. KG). Higher functional polythiol curing agents may include dipentaerythritol hexa-3-mercaptopropionate (commercially available as THIOCURE® DiPETMP from BRUNO BOCK Chemische Fabrik GmbH & Co. KG). Combinations of polythiol curing agents may also be used.

The polythiol curing agent may comprise a mercaptan terminated polysulfide. Commercially available mercaptan terminated polysulfides includes those sold under the trade name THIOKOL® LP from Torray Fine Chemicals Co., Ltd., including, but not limited to, LP-3, LP-33, LP-23, LP-980, LP-2, LP-32, LP-12, LP-31, LP-55 and LP-56. The THIOKOL LP mercaptan terminated polysulfides have the general structure HS—(C₂H₄—O—CH₂—O—C₂H₄—S—S)ₙC₂H₄—O—CH₂—O—C₂H₄—SH, wherein n is an integer of 5 to 50. Other commercially available mercaptan terminated polysulfides include those sold under the trade name THIOPLAST® G™ from AkzoNobel Functional Chemicals GmbH, including, but not limited to, G 10, G 112, G 131, G 1, G 12, G 21, G 22, G 44 and G 4. The THIOPLAST G mercaptan terminated polysulfides are blends of di- and tri-functional mercaptan-functional polysulfides with the di-functional unit having the structure HS—(R—S—S)ₙ—R—SH, wherein n is an integer from 7 to 38, and the tri-functional unit having the structure HS—(R—S—S)ₙ—CH₂—CH((S—S—R)_{c}—SH)—CH₂—(S—S—R)_{b}—SH, wherein a+b+c=n and n is an integer from 7 to 38.

The polythiol curing agent may comprise a mercaptan terminated polyether. Commercially available mercaptan terminated polyether include POLYTHIOL QE-340M available from Toray Fine Chemicals Co., Ltd.

The polythiol curing agent may be present in the second component of the adhesive composition; however, a portion of the polythiol curing agent may be included in the first component such that the polythiol curing agent is present in both the first component and second component of the adhesive composition.

The polythiol curing agent may be present in the second component of the adhesive composition in an amount of at least 20% by weight, based on the total weight of the second component, such as at least 30% by weight, such as at least 35% by weight, such as at least 40% by weight, and may be present in an amount of no more than 95% by weight, such as no more than 75% by weight, such as no more than 60% by weight, such as no more than 50% by weight. The polythiol curing agent may be present in the second component of the adhesive composition in an amount of 20% to 90% by weight, based on the total weight of the second component, such as 30% to 75% by weight, such as 35% to 60% by weight, such as 40% to 50% by weight.

The polythiol curing agent may be present in the adhesive composition in an amount such that the weight ratio of epoxy-containing compounds to polythiol curing agent may be at least 1.4:1, such as at least 1.6:1, such as at least 1.8:1, and may be no more than 15:1, such as no more than 7:1, such as no more than 5:1. The polythiol curing agent may be present in the adhesive composition in an amount such that the weight ratio of epoxy-containing compounds to polythiol curing agent may be 1.4:1 to 15:1, such as 1.6:1 to 7:1, such as 1.8:1 to 5:1.

The polythiol curing agent may also be present in the adhesive composition in an amount sufficient to provide a ratio of epoxide functional groups from the epoxy-containing compounds to thiol functional groups of at least 1.1:1, such as at least 1.5:1, such as at least 2:1, such as at least 2.75:1, such as at least 3:1, such as at least 3.25:1, such as at least 4:1, such as at least 5:1. The polythiol curing agent may also be present in the adhesive composition in an amount sufficient to provide a ratio of epoxide functional groups from the epoxy-containing compounds to thiol functional groups of 1.1:1 to 5:1, 1.5:1 to 5:1, such as 1.5:1 to 4:1, such as 1.5:1 to 3:1, such as 2:1 to 3.5:1, such as 2.75:1 to 3.25:1.

According to the present invention, the adhesive composition may comprise an alkanolamine. The alkanolamine may be present in the second component of the adhesive composition. As used herein, the term “alkanolamine” refers to a compound comprising a nitrogen atom bonded to at least one alkanol substituent comprising an alkyl group comprising a primary, secondary or tertiary hydroxyl group. The alkanolamine may have the general structure R¹ₙN(R²—OH)₃₋ₙ, wherein R¹ comprises hydrogen or an alkyl group, R² comprises an alkanediyl group, and n=0, 1 or 2. When n=2, two R¹ groups will be present, and these groups may be the same or different. When n=0 or 1, 2 or 3 R²—OH groups will be present, and these groups may be the same or different. The alkyl groups comprise aliphatic linear or branched carbon chains that may be unsubstituted or substituted with, for example, ether groups. Suitable alkanolamines include monoalkanolamines such as ethanolamine, N-methylethanolamine, 1-amino-2-propanol, and the like, dialkanolamines such as diethanolamine, diisopropanolamine, and the like, and trialkanolamines such as trimethanolamine, triethanolamine, tripropanolamine, tributanolamine, tripentanolamine, trihexanolamine, triisopropanolamine, and the like.

The alkanolamine may serve dual-purposes in the adhesive composition. For one, the alkanolamine may function as a catalyst during the first-step, the second-step, or both steps of the two-step curing process. For another, the alkanolamine may serve as a reactant during the second-step of the two-step curing process as the hydroxyl group(s) of the alkanolamine may react with the epoxide groups of the epoxy-containing compounds during cure. As used herein, the term “two-step curing process” refers to a process comprising a first-step during which the adhesive composition is allowed to cure at room temperature or slightly thermal conditions followed by a second step during which the adhesive composition may be subjected to an external heat source to further react the components of the adhesive composition and effectuate cure of the adhesive composition.

It has been surprisingly discovered that the use of an alkanolamine in the amounts taught herein allows for the production of a two-component adhesive composition that provides sufficient green strength after the first-step of the two-step curing process and excellent mechanical properties following the second-step of the two-step curing process. For example, the alkanolamine in the amounts taught herein may result in unexpectedly improved wedge impact strength following the second-step of the two-step curing process compared to an adhesive that does not include the alkanolamine.

The alkanolamine may be present in the second component of the adhesive composition in an amount of at least 0.5% by weight, based on the total weight of the second component, such as at least 11% by weight, such as at least 15% by weight, such as at least 18% by weight, and may be present in an amount of no more than 40% by weight, such as no more than 30% by weight, such as no more than 25% by weight, such as no more than 22% by weight. The alkanolamine may be present in the second component of the adhesive composition in an amount of 0.5% to 40% by weight, based on the total weight of the second component, such as 11% to 30% by weight, such as 15% to 25% by weight, such as 18% to 22% by weight.

The alkanolamine may be present in the second component of the adhesive composition in an amount such that the weight ratio of polythiol curing agent to alkanolamine may be at least 1:1, such as at least 1.5:1, such as at least 2:1, such as at least 2.2:1, and may be no more than 22:1, such as no more than 10:1, such as no more than 3:1, such as no more than 2.5:1, such as no more than 2.3:1. The alkanolamine may be present in the second component of the adhesive composition in an amount such that the weight ratio of polythiol curing agent to alkanolamine may be 1:1 to 22:1, such as 1.5:1 to 10:1, such as 1.5:1 to 3:1, such as 2:1 to 2.5:1, such as 2.2:1 to 2.3:1.

The alkanolamine may be present in the adhesive composition in an amount such that the molar ratio of polythiol curing agent to alkanolamine may be at least 0.2:1, such as at least 0.4:1, such as at least 0.5:1, and may be no more than 10:1, such as no more than 7:1, such as no more than 6:1. The alkanolamine may be present in the adhesive composition in an amount such that the molar ratio of polythiol curing agent to alkanolamine may be 0.2:1 to 10:1, such as 0.4:1 to 7:1, such as 0.5:1 to 6:1.

The alkanolamine may be present in the adhesive composition in an amount such that the weight ratio of epoxy-containing compounds to alkanolamine may be at least 3:1, such as at least 4:1, such as at least 5:1, such as at least 6:1, and may be no more than 130:1, such as no more than 60:1, such as no more than 37:1, such as no more than 19:1, such as no more than 12:1. The alkanolamine may be present in the adhesive composition in an amount such that the weight ratio of epoxy-containing compounds to alkanolamine may be 3:1 to 130:1, such as 4:1 to 60:1, such as 5:1 to 37:1, such as 6:1 to 19:1, such as 6:1 to 12:1.

According to the present invention, the second component of the adhesive composition may comprise one or more first-step curing catalysts. As used herein, a “first-step curing catalyst” refers to a compound that may actively catalyze the reaction of thiol-containing compounds and epoxide-containing compounds during the first-step of the two-step curing process. It should be understood that the first-step curing catalyst may remain catalytically active during the second-step of the two-step curing process. The first-step curing catalyst may comprise tertiary amines, cyclic tertiary amines, secondary amines that react with an epoxide group of an epoxy-containing compound at room temperature to form a tertiary amine, or secondary amines that react with a thiol group of the polythiol curing agent to form a thiolate ion that may further react with an epoxide group of an epoxy-containing compound to form a tertiary amine. The secondary amine may also react with an epoxide group of an epoxy-containing compound to form a tertiary amine. The cyclic tertiary amine may comprise 1,4-diazabicyclo[2.2.2]octane (“DABCO”), 1,8-diazabicylo[5.4.0]undec-7-ene (“DBU”), 1,5-diazabicyclo[4.3.0]non-5-ene (“DBN”), 1,5,7-triazabicyclo[4.4.0]dec-5-ene (“TBD”), and combinations thereof. Additional examples of suitable curing catalysts include, pyridine, imidazole, dimethylaminopyridine, 1-methylimidazole, N,N′-carbonyldiimidazole, [2,2]bipyridine, 2,4,6-tris(dimethylamino methyl)phenol, 3,5-dimethylpyrazole, and combinations thereof.

The first-step curing catalysts may be present in the second component of the adhesive composition in an amount of at least 0.05% by weight, based on the total weight of the second component, such as at least 0.1% by weight, such as at least 0.15% by weight, such as at least 0.2% by weight, and may be present in an amount of no more than 2% by weight, such as no more than 1% by weight, such as no more than 0.8% by weight, such as no more than 0.7% by weight. The first-step curing catalysts may be present in the second component of the adhesive composition in an amount of 0.05% to 2% by weight, based on the total weight of the second component, such as 0.1% to 1% by weight, such as 0.15% to 0.8% by weight, such as 0.2% to 0.7% by weight.

The first-step curing catalysts may be present in the adhesive composition in an amount such that the weight ratio of epoxy-containing compounds to first-step curing catalysts may be at least 235:1, such as at least 245:1, such as at least 250:1, and may be no more than 460:1, such as no more than 450:1, such as no more than 442:1. The first-step curing catalysts may be present in the adhesive composition in an amount such that the weight ratio of epoxy-containing compounds to first-step curing catalysts may be 235:1 to 460:1, such as 245:1 to 450:1, such as 250:1 to 442:1.

According to the present invention, the adhesive composition may be substantially free of aromatic amine curing catalysts. As used herein, the term “aromatic amine curing catalyst” refers to amine compounds having an aromatic group. Examples of aromatic groups include phenyl and benzyl groups. As used herein, an adhesive composition may be “substantially free” of aromatic amine curing catalysts if aromatic amine curing catalysts are present in an amount of 0.1% or less by weight, based on the total weight of the adhesive composition. The adhesive composition may be essentially free of aromatic amine curing catalysts. As used herein, an adhesive composition may be “essentially free” of aromatic amine curing catalysts if aromatic amine curing catalysts are present in an amount of 0.01% or less by weight, based on the total weight of the adhesive composition. The adhesive composition may be completely free of aromatic amine curing catalysts. As used herein, an adhesive composition may be “completely free” of aromatic amine curing catalysts if aromatic amine curing catalysts are not present in the adhesive composition, i.e., 0.00% by weight.

According to the present invention, the adhesive composition may optionally comprise one or more second-step curing catalysts. As used herein, the term “second-step curing catalyst” refers to a heat-activated latent curing catalyst that catalyzes the curing reactions of the adhesive composition during the second-step of the curing process only. As used herein, a “heat-activated latent curing catalyst” refers to a compound that requires activation from the application of heat to the adhesive composition prior to the heat-activated latent curing catalyst having a catalytic effect. For example, the heat-activated latent curing catalyst may be in the form of a solid at room temperature and have no catalytic effect until it is heated and melts, or the heat-activated latent curing catalyst may be reversibly reacted with a second compound that prevents any catalytic effect until the reversible reaction is reversed by the application of heat and the second compound is removed, freeing the catalyst to catalyze reactions.

The second-step curing catalysts that may be used include guanidines, substituted guanidines, substituted ureas, melamine resins, guanamine derivatives, heat-activated cyclic tertiary amines, aromatic amines and/or mixtures thereof. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide). Representatives of suitable guanamine derivatives which may be mentioned are alkylated benzoguanamine resins, benzoguanamine resins or methoxymethylethoxymethylbenzoguanamine. In addition, catalytically-active substituted ureas may also be used. Suitable catalytically-active substituted ureas include p-chlorophenyl-N,N-dimethylurea, 3-phenyl-1,1-dimethylurea (fenuron) or 3,4-dichlorophenyl-N,N-dimethylurea (also known as Diuron).

The second-step curing catalyst may also comprise a reaction product of reactants comprising (i) an epoxy compound, and (ii) an amine and/or an alkaloid. For example, the (b) heat-activated latent curing catalyst may comprise a reaction product of reactants comprising (i) an epoxy compound and (ii) an amine, or a reaction product of reactants comprising (i) an epoxy compound and (ii) an alkaloid. Such heat-activated latent curing catalysts are described in paragraphs [0098] through [0110] of U.S. Publication No. 2014/0150970, the cited portion of which is incorporated herein by reference. Examples of non-limiting commercially available second-step curing catalysts comprising a reaction product of reactants comprising (i) an epoxy compound, and (ii) an amine and/or an alkaloid include the products sold under the trade name Ajicure including Ajicure PN-23, Ajicure PN-H, Ajicure PN-31, Ajicure PN-40, Ajicure PN-50, Ajicure PN-23J, Ajicure PN-31J, Ajicure PN-40J, Ajicure MY-24 and Ajicure MY-2, available from Ajinomoto Fine-Techno Co., Inc.

The second-step curing catalyst may be present in the second component of the adhesive composition in an amount of at least 1% by weight, based on the total weight of the second component, such as at least 5% by weight, such as at least 7% by weight, and may be present in an amount of no more than 20% by weight, such as no more than 15% by weight, such as no more than 13% by weight. The second-step curing catalyst may be present in the second component of the adhesive composition in an amount of 1% to 20% by weight, based on the total weight of the second component of the adhesive composition, such as 5% to 15% by weight, such as 7% to 13% by weight.

The second-step curing catalyst may be present in the adhesive composition in an amount such that the weight ratio of alkanolamine to second-step curing catalyst may be 0.9:1 to 4:1, such as 1.2:1 to 3:1, such as 1.5:1 to 2.5:1. The second-step curing catalyst may be present in the second component of the adhesive composition in an amount such that the weight ratio of alkanolamine to second-step curing catalyst may be 0.9:1, such as 1.2:1, such as 1.5:1, such as 2.5:1, such as 3:1, such as 4:1.

The second-step curing catalyst may be present in the adhesive composition in an amount such that the weight ratio of epoxy-containing compounds to second-step curing catalyst may be at least 8:1, such as at least 10:1, such as at least 12:1, and may be no more than 32:1, such as no more than 28:1, such as no more than 26:1. The second-step curing catalyst may be present in the adhesive composition in an amount such that the weight ratio of epoxy-containing compounds to second-step curing catalyst may be 8:1 to 32:1, such as 10:1 to 28:1, such as 12:1 to 26:1.

According to the present invention, the adhesive composition may be substantially free, essentially free, or completely free of a second-step curing catalyst. As used herein, an adhesive composition is “substantially free” of a second-step curing catalyst if the second-step curing catalyst is present in an amount of less than 1% by weight, based on the total weight of the adhesive composition. As used herein, an adhesive composition is “essentially free” of a second-step curing catalyst if the second-step curing catalyst is present in an amount of less than 0.1% by weight, based on the total weight of the adhesive composition. As used herein, an adhesive composition is “completely free” of a second-step curing catalyst if the second-step curing catalyst is not present the adhesive composition, i.e., 0.0% by weight.

According to the present invention, the first-step curing catalysts and second-step curing catalysts may be present in the second component of the adhesive composition in a combined amount of at least 1% by weight, such as at least 5% by weight, such as at least 8% by weight, and may be present in an amount of no more than 17% by weight, such as no more than 15% by weight, such as no more than 13% by weight, based on the total weight of the second component. The first-step curing catalysts and second-step curing catalysts may be present in the second component of the adhesive composition in a combined amount of 1% to 17% by weight, such as 5% to 15% by weight, such as 8% to 13% by weight, based on the total weight of the second component.

According to the present invention, the first-step curing catalysts and second-step curing catalysts may be present in the adhesive composition in a combined amount of at least 0.5% by weight, such as at least 1% by weight, such as at least 2% by weight, and may be present in an amount of no more than 10% by weight, such as no more than 6% by weight, such as no more than 4% by weight, based on the total weight of the adhesive composition. The first-step curing catalysts and second-step curing catalysts may be present in the adhesive composition in a combined amount of 0.5% to 10% by weight, such as 1% to 6% by weight, such as 2% to 4% by weight, based on the total weight of the adhesive composition.

According to the present invention, the first-step curing catalysts and second-step curing catalysts may be present in the adhesive composition in a combined amount such that the weight ratio of epoxy-containing compound to total curing catalyst may be 6:1 to 40:1, such as 9:1 to 30:1, such as 11:1 to 25:1.

Optionally, the adhesive composition may also comprise rubber particles having a core-shell structure in either the first component or the second component. Suitable core-shell rubber particles may be comprised of butadiene rubber or other synthetic rubbers, such as styrene-butadiene and acrylonitrile-butadiene and the like. The type of synthetic rubber and the rubber concentration is not limited as long as the particle size falls within the specified range as illustrated below.

According to the present invention, the average particle size of the rubber particles may be from 0.02 to 500 microns (20 nm to 500,000 nm), for example, the reported particle size for rubber particles provided by Kanekea Texas Corporation, as measured by standard techniques known in the industry, such as, for example, according to ISO 13320 and ISO 22412.

The core-shell rubber particles may be included in an epoxy carrier resin for introduction to the first component of the adhesive composition. Suitable finely dispersed core-shell rubber particles in an average particle size ranging from 50 nm to 250 nm may be master-batched in an epoxy resin such as aromatic epoxides, phenolic novolac epoxy resin, diglycidyl ethers of Bisphenol A or Bisphenol F, and aliphatic epoxides, which include cyclo-aliphatic epoxides at a concentration ranging from 20% to 40% by weight, based on the total weight of the core-shell rubber and epoxy resin mixture. Suitable epoxy resins may also include a mixture of epoxy resins.

Exemplary non-limiting commercial core-shell rubber particle products using poly(butadiene) rubber particles that may be utilized in the first component include a core-shell poly(butadiene) rubber dispersion (25% rubber by weight) in bisphenol F diglycidyl ether (commercially available as Kane Ace MX 136), a core-shell poly(butadiene) rubber dispersion (33% rubber by weight) in Epon® 828 (commercially available as Kane Ace MX 153), a core-shell poly(butadiene) rubber dispersion (37% rubber by weight) in bisphenol A diglycidyl ether (commercially available as Kane Ace MX 257), a core-shell poly(butadiene) rubber dispersion (40% rubber by weight) in bisphenol A diglycidyl ether (commercially available as Kane Ace MX 150), and a core-shell poly(butadiene) rubber dispersion (37% rubber by weight) in bisphenol F diglycidyl ether (commercially available as Kane Ace MX 267), each available from Kaneka Texas Corporation.

Exemplary non-limiting commercial core-shell rubber particle products using styrene-butadiene rubber particles that may be utilized in the first component include a core-shell styrene-butadiene rubber dispersion (33% rubber by weight) in low viscosity bisphenol A diglycidyl ether (commercially available as Kane Ace MX 113), a core-shell styrene-butadiene rubber dispersion (25% rubber by weight) in bisphenol A diglycidyl ether (commercially available as Kane Ace MX 125), a core-shell styrene-butadiene rubber dispersion (25% rubber by weight) in D.E.N.™-438 phenolic novolac epoxy (commercially available as Kane Ace MX 215), a core-shell styrene-butadiene rubber dispersion (25% rubber by weight) in Araldite® MY-721 multi-functional epoxy (commercially available as Kane Ace MX 416), a core-shell styrene-butadiene rubber dispersion (25% rubber by weight) in MY-0510 multi-functional epoxy (commercially available as Kane Ace MX 451), a core-shell styrene-butadiene rubber dispersion (25% rubber by weight) in Syna Epoxy 21 Cyclo-aliphatic Epoxy from Synasia (commercially available as Kane Ace MX 551), and a core-shell styrene-butadiene rubber dispersion (25% rubber by weight) in polypropylene glycol (MW 400) (commercially available as Kane Ace MX 715), each available from Kaneka Texas Corporation. Other commercially available core-shell rubber particle dispersions include Fortegra 352 (33% core-shell rubber particles by weight in bisphenol A liquid epoxy resin), available from Olin Corporation. Other commercially available core-shell rubber particle dispersions include Paraloid™ EXL 2650A (core-shell poly(butadiene) commercially available from Dow).

The core-shell rubber particles may be present in the first component of the adhesive composition in an amount of at least 5% by weight, based on the total weight of the first component, such as at least 10% by weight, such as at least 20% by weight, such as at least 22% by weight, and may be present in an amount of no more than 40% by weight, such as no more than 35% by weight, such as no more than 30% by weight, such as no more than 28% by weight. The core-shell rubber particles may be present in the first component of the adhesive composition in an amount of 5% to 40% by weight, based on the total weight of the first component, such as 10% to 35% by weight, such as 20% to 30% by weight, such as 22% to 28% by weight.

The core-shell rubber particles may be present in the adhesive composition in an amount such that the weight ratio of epoxy-containing compounds to core-shell rubber particles may be at least 2:1, such as at least 2.2:1, such as at least 2.3:1, and may be no more than 3.75:1, such as no more than 3.5:1, such as no more than 3.25:1. The core-shell rubber particles may be present in the adhesive composition in an amount such that the weight ratio of epoxy-containing compounds to core-shell rubber particles may be 2:1 to 3.75:1, such as 2.2:1 to 3.5:1, such as 2.3:1 to 3.25:1.

According to the present invention, the adhesive composition may optionally comprise mica. The term “mica” generally refers to sheet silicate (phyllosilicate) minerals. The mica may comprise muscovite mica. Muscovite mica comprises a phyllosilicate mineral of aluminum and potassium with the formula KAl₂(AlSi₃O₁₀)(F,OH)₂ or (KF)₂(Al₂O₃)₃(SiO₂)₆(H₂O). Exemplary non-limiting commercially available muscovite mica include products sold under the trade name DakotaPURE™, such as DakotaPURE™ 700, DakotaPURE™ 1500, DakotaPURE™ 2400, DakotaPURE™ 3000, DakotaPURE™ 3500 and DakotaPURE™ 4000, available from Pacer Minerals.

Mica may be present in the first component of the adhesive composition in an amount of at least 0.5% by weight, based on the total weight of the first component, such as at least 1% by weight, such as at least 1.5% by weight, such as at least 2% by weight, and may be present in an amount of no more than 6% by weight, such as no more than 4% by weight, such as no more than 3% by weight. Mica may be present in the first component of the adhesive composition in an amount of 0.5% to 6% by weight, based on the total weight of the first component, such as 1% to 4% by weight, such as 1.5% to 3% by weight.

Alternatively, or in addition, mica may be present in the second component of the adhesive composition in an amount of at least 1% by weight, based on the total weight of the second component, such as at least 5% by weight, such as at least 9% by weight, such as at least 10% by weight, and may be present in an amount of no more than 20% by weight, such as no more than 15% by weight, such as no more than 11% by weight. Mica may be present in the second component of the adhesive composition in an amount of 1% to 20% by weight, based on the total weight of the second component, such as 5% to 15% by weight, such as 9% to 11% by weight.

Mica may be present in the adhesive composition in an amount such that the weight ratio of epoxy-containing compounds to mica may be at least 7:1, such as at least 7.5:1, such as at least 8.25:1, and may be no more than 20:1, such as no more than 16:1, such as no more than 15:1. Mica may be present in the adhesive composition in an amount such that the weight ratio of epoxy-containing compounds to mica may be 7:1 to 20:1, such as 7.5:1 to 16:1, such as 8.25:1 to 15:1.

According to the present invention, the adhesive composition may optionally comprise calcium oxide (CaO).

Calcium oxide may be present in the first component of the adhesive composition in an amount of at least 0.5% by weight, based on the total weight of the first component, such as at least 1% by weight, such as at least 1.5% by weight, such as at least 2% by weight, and may be present in an amount of no more than 6% by weight, such as no more than 4% by weight, such as no more than 3% by weight. Calcium oxide may be present in the first component of the adhesive composition in an amount of 0.5% to 6% by weight, based on the total weight of the first component, such as 1% to 4% by weight, such as 1.5% to 3% by weight.

Calcium oxide may be present in the first component of the adhesive composition in an amount such that the weight ratio of epoxy-containing compounds to calcium oxide may be at least 18:1, such as at least 22:1, such as at least 24:1, and may be no more than 51:1, such as no more than 47:1, such as no more than 45:1. Calcium oxide may be present in the adhesive composition in an amount such that the weight ratio of epoxy-containing compounds to calcium oxide may be 18:1 to 50:1, such as 22:1 to 47:1, such as 24:1 to 45:1.

According to the present invention, the adhesive composition may optionally comprise silica (SiO₂). The silica may comprise fumed silica which comprises silica that has been treated with a flame to form a three-dimensional structure. The fumed silica may be untreated or surface treated with a siloxane, such as, for example, polydimethylsiloxane. Exemplary non-limiting commercially available fumed silica includes products solder under the trade name AEROSIL®, such as AEROSIL® R 104, AEROSIL® R 106, AEROSIL® R 202, AEROSIL® R 208, commercially available from Evonik Industries.

Silica may be present in the first component of the adhesive composition in an amount of at least 0.10% by weight, based on the total weight of the first component, such as at least 0.18% by weight, such as at least 0.22% by weight, such as at least 0.24% by weight, and may be present in an amount of no more than 0.55% by weight, such as no more than 0.50% by weight, such as no more than 0.45% by weight. Silica may be present in the first component of the adhesive composition in an amount of 0.10% to 0.55% by weight, based on the total weight of the first component, such as 0.18% to 0.50% by weight, such as 0.22% to 0.45% by weight.

Alternatively, or in addition, silica may be present in the second component of the adhesive composition in an amount of at least 1% by weight, based on the total weight of the second component, such as at least 2% by weight, such as at least 4% by weight, and may be present in an amount of no more than 10% by weight, such as no more than 8% by weight, such as no more than 6% by weight. Silica may be present in the second component of the adhesive composition in an amount of 1% to 10% by weight, based on the total weight of the second component, such as 2% to 8% by weight, such as 4% to 6% by weight.

Silica may be present in the adhesive composition in an amount such that the weight ratio of epoxy-containing compounds to silica may be at least 15:1, such as at least 18:1, such as at least 21:1, and may be no more than 45:1, such as no more than 42:1, such as no more than 39:1. Silica may be present in the adhesive composition in an amount such that the weight ratio of epoxy-containing compounds to silica may be 15:1 to 45:1, such as 18:1 to 42:1, such as 21:1 to 39:1.

According to the present invention, the adhesive composition may optionally comprise wollastonite. Wollastonite comprises a calcium inosilicate mineral (CaSiO₃) that may contain small amounts of iron, aluminum, magnesium, manganese, titanium and/or potassium. The wollastonite may have a B.E.T. surface area of 1.5 to 2.1 m²/g, such as 1.8 m²/g and a median particle size of 6 microns to 10 microns, such as 8 microns. Non-limiting examples of commercially available wollastonite include NYAD 400 available from NYCO Minerals, Inc.

Wollastonite may be present in the second component of the adhesive composition in an amount of at least 1% by weight, based on the total weight of the second component, such as at least 8% by weight, such as at least 12% by weight, such as at least 13% by weight, and may be present in an amount of no more than 25% by weight, such as no more than 20% by weight, such as no more than 17% by weight. Wollastonite may be present in the first component of the adhesive composition in an amount of 1% to 25% by weight, based on the total weight of the first component, such as 8% to 20% by weight, such as 12% to 17% by weight.

Wollastonite may be present in the adhesive composition in an amount such that the weight ratio of epoxy-containing compounds to wollastonite may be at least 7:1, such as at least 7.5:1, such as at least 8.25:1, and may be no more than 16:1, such as no more than 15.5:1, such as no more than 15:1. Wollastonite may be present in the adhesive composition in an amount such that the weight ratio of epoxy-containing compounds to wollastonite may be 7:1 to 16:1, such as 7.5:1 to 15.5:1, such as 8.25:1 to 15:1.

Useful clay minerals include a non-ionic platy filler such as talc, pyrophyllite, chlorite, vermiculite, or combinations thereof. Clay minerals may be present in the first component and/or the second component in an amount of at least 0.1 weight % based on total weight of the adhesive composition, such as at least 0.25 weight %, such as at least 0.5 weight %, and may be present in an amount of no more than 30 weight % based on total weight of the adhesive composition, such as no more than 25 weight %, such as no more than 20 weight %. Clay minerals may be present in the first component and/or the second component in an amount of 0.1 weight % to 30 weight % based on total weight of the adhesive composition, such as 0.25 weight % to 25 weight %, such as 0.5 weight % to 20 weight %.

According to the present invention, the first and/or second component of the adhesive composition may optionally comprise one or more reinforcement fillers. Useful reinforcement fillers that may be introduced to the adhesive composition to provide improved mechanical properties include fibrous materials such as fiberglass, fibrous titanium dioxide, fibrous alumina, whisker type calcium carbonate (aragonite), and carbon fiber (which includes graphite and carbon nanotubes).

According to the present invention, other fillers, thixotropes, colorants, tints and other materials may optionally be added to the adhesive composition. Useful thixotropes that may be used include Castor wax, clay, organoclay, fibers such as synthetic fibers like Aramid® fiber and Kevlar® fiber, acrylic fibers, and engineered cellulose fiber may also be utilized. Useful colorants or tints may include red iron pigment, titanium dioxide, calcium carbonate, and phthalocyanine blue. Useful other fillers that may be used in conjunction with thixotropes may include inorganic fillers such as inorganic clay or glass beads.

According to the present invention, the first component and/or the second component of the adhesive composition may optionally comprise graphenic carbon particles. As used herein, the term “graphenic carbon particles” means carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which in incorporated herein by reference. Other suitable graphenic carbon particles are described in U.S. Publication No. 2014/0299270, at paragraphs [0039]-[0054], the cited portion of which in incorporated herein by reference.

According to the present invention, the first component of the adhesive composition may comprise, consist essentially of, or consist of at least one epoxy-containing compound, rubber particles having a core-shell structure as described above, mica, calcium oxide and silica. As used herein, the first component of the adhesive composition consists essentially of at least one epoxy-containing compound, mica, calcium oxide and silica when the maximum amount of other components is 5% by weight or less, based on the total weight of the first component.

According to the present invention, the second component of the adhesive composition may comprise, consist essentially of, or consist of at least one polythiol curing agent, a curing catalyst comprising an alkanolamine, mica, wollastonite and silica and optionally a second-step curing catalyst as described above. As used herein, the second component of the adhesive composition consists essentially of at least one polythiol curing agent, a curing catalyst comprising an alkanolamine, mica, wollastonite and silica and optionally a second-step curing catalyst and/or rubber particles having a core-shell structure as described above when the maximum amount of other components is 5% by weight or less, based on the total weight of the second component.

According to the present invention, the adhesive composition may be substantially free of a color change indicator. As used herein, the term “color change indicator” refers to a compound that at least partially changes the color of the adhesive composition during the curing process. Examples of color change indicators include inorganic and organic dyes, such as azo compounds or azo dyes, including Solvent Red 26 (1-[[2,5-dimethyl-4-[(2-methylphenyl)azo]-phenyl]azo]-2-naphthol) and Solvent Red 164 (1-[[4-[phenylazo]-phenyl]azo]-2-naphtholor), as well as pH dependent color change indicators, such as, for example, phenolphthalein. As used herein, an adhesive composition is “substantially free” of color change indicator if color change indicator is present in the adhesive composition in an amount of 0.05% or less, based on the total weight of the adhesive composition. The adhesive composition may be essentially free of color change indicator. As used herein, an adhesive composition is “essentially free” of color change indicator if color change indicator is present in the adhesive composition in an amount of 0.01% or less, based on the total weight of the adhesive composition. The adhesive composition may be completely free of color change indicator. As used herein, an adhesive composition is “completely free” of color change indicator if color change indicator is not present in the adhesive composition, i.e., 0.0% by weight.

According to the present invention, the adhesive composition may be substantially free of silane. As used herein, an adhesive composition is “substantially free” of silane if silane is present in the adhesive composition in an amount of 0.5% by weight or less, based on the total weight of the adhesive composition. The adhesive composition may be essentially free of silane. As used herein, an adhesive composition is “essentially free” of silane if silane is present in the adhesive composition in an amount of 0.1% by weight or less, based on the total weight of the adhesive composition. The adhesive composition may be completely free of silane. As used herein, an adhesive composition is “completely free” of silane if silane is not present in the adhesive composition, i.e., 0.0% by weight.

The present invention may also be a method for preparing an adhesive composition comprising, or in some cases consisting of, or in some cases consisting essentially of, an epoxy-containing component, rubber particles having a core-shell structure, and any of the curing components described above, the method comprising, or in some cases consisting of, or in some cases consisting essentially of, mixing the epoxy-containing component, the rubber particles having a core-shell structure and the curing component at a temperature of less than 50° C., such as from 0° C. to 50° C., such as from 15° C. to 35° C., such as at ambient temperature.

The present invention is also directed to a method for forming a bond between two substrates comprising, or in some cases consisting of, or in some cases consisting essentially of, mixing the two-components of the adhesive composition, applying the adhesive composition described above to a first substrate; contacting a second substrate to the adhesive composition such that the adhesive composition is located between the first substrate and the second substrate; and curing the adhesive composition, such as, for example, by applying a two-step curing process as described herein.

The adhesive composition described above may be applied alone or as part of an adhesive system that can be deposited in a number of different ways onto a number of different substrates. The adhesive system may comprise a number of the same or different adhesive layers. An adhesive layer is typically formed when an adhesive composition that is deposited onto the substrate is at least partially cured by methods known to those of ordinary skill in the art (e.g., by exposure to thermal heating).

The adhesive composition can be applied to the surface of a substrate in any number of different ways, non-limiting examples of which include brushes, rollers, films, pellets, spray guns and applicator guns.

After application to the substrate(s), the adhesive composition may be cured. Cure may be accomplished by a two-step curing process as discussed above. For example, the adhesive may be allowed to cure at room temperature or slightly thermal conditions during the first step. Next, the adhesive may be cured during the second step by baking and/or curing at elevated temperature, such as at a temperature of at least 110° C., such as at least 120° C., such as at least 125° C., such as at least 130° C., and in some cases at a temperature of no more than 200° C., such as no more than 180° C., such as no more than 170° C., such as no more than 165° C., and in some cases at a temperature of from 110° C. to 200° C., from 120° C. to 180° C., from 125° C. to 170° C., from 130° C. to 165° C., and for any desired time period (e.g., from 5 minutes to 1 hour) sufficient to at least partially cure the adhesive composition on the substrate(s).

After the adhesive composition is applied to a substrate and at least partially cured by the first-step of the curing process, the bonded substrate(s) may demonstrate a lap shear after 4 hours exposure to ambient temperature of at least 1.0 MPa as measured according to test method ASTM D1002-10 by an Instron model 5567 in tensile mode, such as at least 1.5 MPa, such as at least 2.0 MPa, such as at least 2.5 MPa, such as at least 3.0 MPa.

After the adhesive composition is applied to a substrate and at least partially cured by the second-step of the curing process, the bonded substrate(s) may demonstrate a lap shear after 4 hours exposure to ambient temperature and heating at 130° C. for 30 minutes of at least 5.0 MPa as measured according to test method ASTM D1002-10 by an Instron model 5567 in tensile mode, such as at least 6.0 MPa, such as at least 7.0 MPa, such as at least 8.0 MPa, such as at least 9.0 MPa, such as at least 10.0 MPa.

After the adhesive composition is applied to a substrate and at least partially cured by the second-step of the curing process, the bonded substrate(s) may also be evaluated for cohesive failure. The cohesive failure of an adhesive bond may be qualitatively evaluated after the bond has been subjected to a process that separates the substrate(s) bound by the adhesive bond, such as, for example, a lap shear test. The cohesive failure is an evaluation of the breakage of the adhesive bond after the substrate(s) has been separated, specifically evaluating how much adhesive remains on the substrate(s) after they have been separated. The cohesive failure is rated on a scale of 1 to 5, wherein a value of 1 indicates an interfacial failure leaving the adhesive on one substrate and the other substrate as bare material (one substrate has about <10% surface coverage), and a value of 5 indicates a failure within the adhesive leaving approximately equal thickness of adhesive on both substrates (both substrates have about >90% surface coverage with adhesive). The intermediate values are based on the fact that one substrate will have >90% surface coverage of the adhesive and the other substrate may have about 10% of surface coverage with the adhesive (a value of 2), about 35% of surface coverage with the adhesive (a value of 3), or about 60% surface coverage with the adhesive (a value of 4).

After the adhesive composition is applied to a substrate and at least partially cured by the second-step of the curing process, the bonded substrate(s) may also be evaluated for wedge impact. The wedge impact test evaluates the fracture behavior of adhesively bonded joints when subjected to impact. The wedge impact is measured according to ISO 11343. An acceptable value in the automotive industry, for example, may be at least 10 N/mm, such as at least 15 N/mm. As discussed above, it has been surprisingly found that the use of the alkanolamine in the adhesive composition of the present invention results in improved wedge impact performance compared to an adhesive composition that does not include an alkanolamine. For example, the wedge impact may be improved by at least 50% compared to a comparative adhesive composition that does not include an alkanolamine, such as at least 60%, such as at least 75%, such as at least 90%, such as at least 100%.

As stated above, the present disclosure is directed to adhesive compositions that are used to bond together two substrate materials for a wide variety of potential applications in which the bond between the substrate materials provides particular mechanical properties related to lap shear strength and/or T-peel strength. The adhesive composition may be applied to either one or both of the substrate materials being bonded such as, by way of non-limiting example, components of an automobile frame. The pieces are aligned and pressure and/or spacers may be added to control bond thickness, and the adhesive composition may be allowed to partially cure at room temperature. The adhesive bond formed the adhesive composition of the present invention provides sufficient green strength to allow the part to be subjected to other stages in an automobile assembly plant, such as cleaning, pretreating, coating with an electrodepositable coating composition and additional coating layers such as a primer, basecoat or top coat. The adhesive composition may be applied to cleaned or uncleaned (i.e., including oily or oiled) substrate surfaces. Parts coated with coating compositions are subsequently baked in an oven to cure the coating composition. The adhesive composition of the present invention may be subjected to the second step of the two-step curing process during the curing of any coating composition applied to the part when the part is heated in an oven or during a separate heating step.

Suitable substrate materials that may be bonded by the adhesive compositions of the present invention include, but are not limited to, materials such as metals or metal alloys, glass, natural materials such as wood, polymeric materials such as hard plastics, or composite materials. The adhesives of the present invention are particularly suitable for use in various automotive or industrial applications.

The present invention is also directed to the adhesive bond formed between one or more substrates by the adhesive composition of the present invention in an at least partially cured state.

As used herein, the term “structural adhesive” means an adhesive producing a load-bearing joint after the two-step curing process having a lap shear strength of greater than 5 MPa, as determined according to ASTM D1002-10 by using an Instron 5567 machine in tensile mode with a pull rate of 1.3 mm per minute.

For purposes of this detailed description, it is to be understood that the invention may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “a” polythiol curing agent, “an” epoxy-containing compound, “a” curing catalyst, “a” polyol, “an” anhydride, and “a” diacid, a combination (i.e., a plurality) of these components may be used. In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### Aspects

1. An adhesive composition comprising:

a first component; and

a second component that chemically reacts with the first component, the second component comprising:
a polythiol curing agent; and
an alkanolamine.
   2. The adhesive composition of Aspect 1, wherein the first component comprises one or more epoxy-containing compounds.
   3. The adhesive composition of Aspect 1 or 2, wherein the polythiol curing agent is present in the second component in an amount sufficient to provide a ratio of epoxide functional groups from the first component to thiol functional groups from the second component of 1.1:1 to 5:1.
   4. The adhesive composition of any of the preceding Aspects, wherein the first component further comprises core-shell rubber particles.
   5. The adhesive composition of any of the preceding Aspects, wherein the polythiol curing agent comprises pentaerythritol tetra-3-mercaptopropionate.
   6. The adhesive composition of any of the preceding Aspects, wherein the weight ratio of polythiol curing agent to alkanolamine is 1:1 to 22:1.
   7. The adhesive composition of any of the preceding Aspects, further comprising a first-step curing catalyst comprising a cyclic tertiary amine.
   8. The adhesive composition of any of the preceding Aspects, wherein the alkanolamine comprises triethanolamine.
   9. The adhesive composition of any of the preceding Aspects, wherein the alkanolamine is present in the second component of the adhesive composition in an amount of at least 0.5% by weight, based on the total weight of the second component.
   10. The adhesive composition of any of the preceding Aspects, wherein the adhesive composition further comprises a second-step curing catalyst, wherein the second-step curing catalyst preferably comprises a heat-activated latent curing catalyst.
   11. The adhesive composition of any of the preceding Aspects, wherein the adhesive composition cures by a two-step curing process, wherein a first-step comprises that at least a portion of the first component and the second component chemically react when mixed to partially cure the adhesive composition without activation from an external energy source, wherein the second-step comprises application of an external energy source to the adhesive composition to further cure the adhesive composition, wherein the external energy source of the second-step preferably comprises application of an external heat source to heat the adhesive composition to a temperature of at least 110° C. for a period of at least 30 minutes.
   12. The adhesive composition of Aspect 11, wherein the adhesive composition after the first-step has a lap shear of at least 1.0 MPa as measured according to test method ASTM D1002-10 by an Instron model 5567 in tensile mode and/or wherein the adhesive composition after the second-step has a lap shear of at least 5.0 MPa as measured according to test method ASTM D1002-10 by an Instron model 5567 in tensile mode.
   13. The adhesive composition of any of the preceding Aspects, wherein the adhesive composition is substantially free of a color change indicator, aromatic amine curing catalysts and/or silane.
   14. A method for forming a bond between two substrates comprising:

applying the adhesive composition of any of the preceding Aspects to a first substrate;

contacting a second substrate to the adhesive composition such that the adhesive composition is located between the first substrate and the second substrate; and

curing the adhesive composition by a two-step curing process.

15. The method of Aspect 14, wherein the first substrate and second substrate comprise components of an automobile frame.

Illustrating the invention are the following examples, which, however, are not to be considered as limiting the invention to their details. Unless otherwise indicated, all parts and percentages in the following examples, as well as throughout the specification, are by weight.

### EXAMPLES

### Example A: Synthesis of Polycaprolactone Diol Modified Epoxy Resin

948 g of methylhexahydrophthalic anhydride (“MHHPA”, commercially available from Dixie Chemical) and 4,054.7 g of Epon 828 (bisphenol A diglycidyl ether epoxy resin commercially available from Hexion Specialty Chemicals) were added to a 12-liter, 4-necked kettle equipped with a motor driven stainless steel stir blade, a water-cooled condenser, a nitrogen blanket, and a heating mantle with a thermometer connected through a temperature feedback control device. The contents of flask were heated to 90° C. and held for 30 minutes. 2,064.0 g of Capa 2077A (polycaprolactone-based diol commercially available from Perstorp Group) was added and the reaction mixture was held at 90° C. for 30 minutes. 395.9 g of Epon 828 and 46.4 g of triphenyl phosphine (available from Sigma Aldrich) were added and the mixture exothermed and was heated to 120° C. after exotherm. The reaction mixture was held at 120° C. until the acid value was less than 2 mg KOH/g by titration using a Metrohm 888 Titrando and 0.1 N KOH solution in Methanol as the titration reagent. The reaction temperature was cooled to 80° C. and the resin was poured out from the flask. The Epoxy equivalent of this epoxy adduct was 424 g/epoxide as determined by titration using a Metrohm 888 Titrando and 0.1 N Perchloric acid in glacial acetic acid. The weight average molecular weight was 3,670 g/mol as determined by Gel Permeation Chromatography using a Waters 2695 separation module with a Waters 410 differential refractometer (RI detector) and polystyrene standards. Tetrahydrofuran (THF) was used as the eluent at a flow rate of 1 ml min′, and two PL Gel Mixed C columns were used for separation. The epoxy adduct prepared by this procedure is referred to as CAPA di-/MHHPA/Epon 828 in the following examples.

### Example B: Synthesis of Polycaprolactone Tetraol Modified Epoxy Resin

1,038.6 g of MHHPA and 4,439.3 g of Epon 828 were added to a 12-liter, 4-necked kettle equipped with a motor driven stainless steel stir blade, a water-cooled condenser, a nitrogen blanket, and a heating mantle with a thermometer connected through a temperature feedback control device. The contents of flask were heated to 90° C. and held for 30 minutes. 1,589.1 g of Capa 4101 (polycaprolactone-based tetraol commercially available from Perstorp Group) was added and the reaction mixture was held at 90° C. for 30 minutes. 433.5 g of Epon 828 and 43.6 g of triphenylphosphine were added and the mixture exothermed and was heated to 120° C. after exotherm. The reaction mixture was held at 120° C. until the acid value was less than 2 mg KOH/g as determined by titration according to the procedure described above. The reaction mixture was cooled to 80° C. and the resin was poured out from flask. The Epoxy equivalent of this epoxy adduct was 412 g/epoxide as determined by titration according to the procedure described above. The weight average molecular weight was 18,741 g/mol as determined by the procedure described above. The epoxy adduct prepared by this procedure is referred to as CAPA tetra-/MHHPA/Epon 828 in the following examples.

### Preparation of Adhesive Compositions

The adhesive compositions of Examples 1-6 described below were prepared according to the following procedure with all non-manual mixing performed using a Speedmixer DAC 600FVZ (commercially available from FlackTeck, Inc.): For each adhesive composition described below, the components included under “Resins” of Part A were combined and mixed for 1 minute at 2,350 revolutions per minutes (“RPM”). The mixture was allowed to cool down to room temperature (about 23° C.). The ingredients listed as “Fillers” of Part A were then added and mixed for one minute at 2,350 RPM. The mixture was examined with a spatula and given additional mix time, if necessary, to ensure uniformity. In a separate container, all components of Part B were combined and mixed for 30 seconds at 2,350 RPM. The mixture was examined with a spatula and given additional mix time, if necessary, to ensure uniformity. A 19.2:35.4 mix ratio by weight of Part A to Part B was targeted. Appropriate weights of Part A and Part B were combined and mixed manually using a spatula for 20 seconds.

The adhesive composition was applied to substrates and following cure the substrates with the adhesive formed thereon were tested for lap shear strength according to the following procedure: The substrates used were 0.79 mm×25 mm×100 mm hot dip galvanized (HDG) steel panels (“coupons”) from ACT. Coupons were scribed at one end at 12.5 mm. A thin coating of oil (Quaker Ferrocote® 61A US) was evenly applied over the coupons within the scribed area. Then, adhesive was applied on one of the coupons of the bond assembly. Uniformity of bond thickness was ensured by addition of 0.25 mm glass spacer beads. Spacer beads were sprinkled evenly over the material, covering no more than 5% of the total bond area. The other test coupon was placed on the bond area and spring-loaded clips were attached one to each side of the bond to hold the assembly together. Excess adhesive that squeezed out was removed with a spatula. Bond assemblies were stored under ambient conditions for 4 hours prior to baking at 160° C. for 30 minutes. Lap shear tests were conducted according to ASTM D1002-10. Bonds were inserted in wedge action grips and pulled apart at a rate of 1.3 mm/min using an Instron model 5567 in tensile mode. Shear strength and extension at break were calculated by Instron's Blue Hill software package. Extension at break was the displacement of the action grips at break. In some instances, lap shear strength was measured following storage at ambient temperature for 4 hours and 24 hours.

In some instances, cohesive failure was qualitatively determined by evaluating the bond after it was subjected to a process that separates the substrate(s) bound by the adhesive bond, such as, for example, a lap shear test or wedge impact test. The cohesive failure of a bond was rated on a scale of 1 to 5, wherein a value of 1 indicated an interfacial failure of the bond and substrate leaving the adhesive on one substrate and the other substrate as bare metal (i.e., one substrate has <10% adhesive surface coverage after the bonded substrates were pulled apart), and a value of 5 indicated a failure within the adhesive bond leaving approximately equal thickness of adhesive on both substrates (i.e., both substrates have about >90% surface coverage with adhesive). The intermediate values were based on the fact that one substrate had about >90% surface coverage of the adhesive and the other substrate had about 10% of surface coverage with the adhesive (a value of 2), about 35% of surface coverage with the adhesive (a value of 3), or about 60% surface coverage with the adhesive (a value of 4), as visually inspected.

### Example 1

TABLE 1A
Ingredients (g) for Adhesives 1 and 2 of Example 1

| | |
|---|---|
| Adhesive 1 | Adhesive 2 |

Part A

| | | |
|---|---|---|
| Resins | | |
| Kane Ace MX-153¹ | 24 | 24 |
| CAPA di-/MHHPA/Epon 828 | 4.2 | 4.2 |
| (Example A) | | |
| CAPA tetra-/MHHPA/Epon 828 | 5 | 5 |
| (Example B) | | |
| Fillers | | |
| DAKOTAPURE 3000 Mica | 1 | 1 |
| Calcium Oxide | 1 | 1 |
| Aerosil 202² | 0.15 | 0.15 |

Part B

| | | |
|---|---|---|
| Fillers | | |
| DAKOTAPURE 3000 Mica³ | 2 | 2 |
| NYAD 400⁴ | 3 | 3 |
| Aerosil 202 | 1 | 1 |
| Polythiol | | |
| THIOCURE PETMP⁵ | — | 9.1 |
| THIOCURE TEMPIC⁶ | 13.04 | — |
| Alkanolamine | | |
| TEA⁷ | 4 | 4 |
| Catalyst | | |
| DABCO⁸ | 0.1 | 0.1 |

¹A core-shell poly(butadiene) rubber dispersion (33% rubber by weight) in Epon 828 commercially available from Kaneka Texas Corporation
²Fumed silica commercially available from Evonik Industries
³Muscovite mica commercially available from Pacer Minerals
⁴Wollastonite commercially available from NYCO Minerals, Inc.
⁵Pentaerythritol tetra-3-mercaptopropionate (a tetrafunctional polythiol) commercially available from BRUNO BOCK Chemische Fabrik GmbH & Co. KG
⁶Tris[2-(3-mercaptopropionyloxy)ethyl]isocyanurate (a trifunctional polythiol) commercially available from BRUNO BOCK Chemische Fabrik GmbH & Co. KG
⁷Triethanolamine
⁸1,4-diazabicyclo[2.2.2]octane

TABLE 1B
Lap Shear, Cohesive Failure, and Extension at Break Data
for Adhesives 1 and 2 of Example 1

| | Adhesive 1¹ | | | Adhesive 2² | | |
|---|---|---|---|---|---|---|
| | Lap | | Exten- | Lap | | Exten- |
| | shear | | sion at | shear | | sion at |
| Cure | strength | Cohesive | break | strength | Cohesive | break |
| Conditions | (MPa) | Failure | (mm) | (MPa) | Failure | (mm) |
| 4 h @ RT | 2.5 | 1/5 | 0.86 | 3.4 | 1/5 | 0.53 |
| 24 h @ RT | 2.2 | 1/5 | 1.48 | — | — | — |
| 4 h @ RT + | 8.8 | 5/5 | 1.15 | 13.8 | 5/5 | 4.48 |
| 160° C. for | | | | | | |
| 30 mins | | | | | | |

¹Includes tri-functional polythiol (TEMPIC)
²Includes tetra-functional polythiol (PETMP)

The adhesive compositions in Example 1 show the impact the functionality of polythiol curing agent has on the properties of the adhesive composition. Specifically, Adhesive 2, which included a tetrafunctional polythiol, had greater lap shear strength and greater extension at break following a 4-hour cure at room temperature and following the second step of the cure process (baking at 160° C. for 30 mins) compared to Adhesive 1, which included a trifunctional polythiol. Additionally, cohesive failure was improved in both Adhesive 1 and Adhesive 2 following the second step of the cure compared to adhesives cured only at room temperature.

### Example 2

TABLE 2A
Ingredients (g) for Adhesives 3-7 of Example 2

| | | | | |
|---|---|---|---|---|
| Adhe- | Adhe- | Adhe- | Adhe- | Adhe- |
| sive 3 | sive 4 | sive 5 | sive 6 | sive 7 |

Part A

| | | | | | |
|---|---|---|---|---|---|
| Resins | | | | | |
| Kane Ace MX-153 | 24 | 24 | 24 | 24 | 24 |
| CAPA | 4.2 | 4.2 | 4.2 | 4.2 | 4.2 |
| di-/MHHPA/Epon 828 | | | | | |
| (Example A) | | | | | |
| CAPA | 5 | 5 | 5 | 5 | 5 |
| tetra-/MHHPA/ | | | | | |
| Epon 828 | | | | | |
| (Example B) | | | | | |
| Fillers | | | | | |
| DAKOTAPURE | 1 | 1 | 1 | 1 | 1 |
| 3000 Mica | | | | | |
| Calcium Oxide | 1 | 1 | 1 | 1 | 1 |
| Aerosil 202 | 0.15 | 0.15 | 0.15 | 0.15 | 0.15 |

Part B

| | | | | | |
|---|---|---|---|---|---|
| Fillers | | | | | |
| DAKOTAPURE | 2 | 2 | 2 | 2 | 2 |
| 3000 Mica | | | | | |
| NYAD 400 | 3 | 3 | 3 | 3 | 3 |
| Aerosil 202 | 1 | 1 | 1 | 1 | 1 |
| Polythiol | | | | | |
| THIOCURE | 9.1 | 9.1 | 9.1 | 9.1 | 9.1 |
| PETMP | | | | | |
| Alkanolamine | | | | | |
| TEA | — | 4 | — | — | 4 |
| Catalyst | | | | | |
| DABCO | — | — | 0.1 | — | 0.1 |
| TBD⁹ | — | — | — | 0.1 | — |

⁹1,5,7-triazabicyclo[4.4.0]dec-5-ene

TABLE 2B
Lap Shear, Cohesive Failure, and Extension at Break for Adhesives 3-7 of Example 2

| | Adhesive 3¹ | | | Adhesive 4² | | | Adhesive 5³ | | | Adhesive 6⁴ | | | Adhesive 7⁵ | | |
|---|---|---|---|---|---|---|---|---|---|---|---|---|---|---|---|
| | Lap | | Ext. | Lap | | Ext. | Lap | | Ext. | Lap | | Ext. | Lap | | Ext. |
| | shear | Co- | at | shear | Co- | at | shear | Co- | at | shear | Co- | at | shear | Co- | at |
| Cure | str. | hesive | break | str. | hesive | break | str. | hesive | break | str. | hesive | break | str. | hesive | break |
| Conditions | (MPa) | Failure | (mm) | (MPa) | Failure | (mm) | (MPa) | Failure | (mm) | (MPa) | Failure | (mm) | (MPa) | Failure | (mm) |
| 4 h @ RT | 0 | — | 0 | 5.1 | 1/5 | 0.75 | 1.4 | 1/5 | 0.07 | 2.8 | 1/5 | 0.13 | 3.4 | 1/5 | 0.53 |
| 24 h @ RT | 0 | — | 0 | 4.7 | 1/5 | 0.81 | 2.0 | 1/5 | 0.11 | 4.4 | 1/5 | 0.27 | — | — | — |
| 4 h @ RT + | 13.1 | 5/5 | 4.07 | 12.1 | 5/5 | 3.08 | 9.8 | 1/5 | 0.90 | 12.3 | 1/5 | 2.88 | 13.8 | 5/5 | 4.48 |
| 160° C. for | | | | | | | | | | | | | | | |
| 30 mins | | | | | | | | | | | | | | | |

¹No catalyst
²TEA only
³DABCO only
⁴TBD only
⁵TEA + DABCO

These data show that Adhesive 3 (without the alkanolamine or any additional catalyst) did not cure at room temperature, while the presence of either alkanolamine (Adhesive 4) or catalyst (Adhesives 5, 6) improved the room temperature cure. The combination of alkanolamine and secondary curing catalysts improved both room temperature and second step cure compared to either alone.

### Example 3

TABLE 3A
Ingredients (g) for Adhesives 7-9 of Example 3

| | | |
|---|---|---|
| Adhesive 7 | Adhesive 8 | Adhesive 9 |

Part A

| | | | |
|---|---|---|---|
| Resins | | | |
| Kane Ace MX-153 | 24 | 32.7 | 52 |
| CAPA di-/MHHPA/Epon 828 | 4.2 | 4.2 | 4.2 |
| (Example A) | | | |
| CAPA tetra-/MHHPA/Epon 828 | 5 | 5 | 5 |
| (Example B) | | | |
| Fillers | | | |
| DAKOTAPURE 3000 Mica | 1 | 1 | 1 |
| Calcium Oxide | 1 | 1 | 1 |
| Aerosil 202 | 0.15 | 0.15 | 0.15 |

Part B

| | | | |
|---|---|---|---|
| Fillers | | | |
| DAKOTAPURE 3000 Mica | 2 | 2 | 2 |
| NYAD 400 | 3 | 3 | 3 |
| Aerosil 202 | 1 | 1 | 1 |
| Polythiol | | | |
| THIOCURE PETMP | 9.1 | 9.1 | 9.1 |
| Alkanolamine | | | |
| TEA | 4 | 4 | 4 |
| Catalyst | | | |
| DABCO | 0.1 | 0.1 | 0.1 |

TABLE 3B
Lap Shear, Cohesive Failure, and Extension at Break Data for Adhesives 7-9 of Example 3

| | Example 7¹ | | | Example 8² | | | Example 9³ | | |
|---|---|---|---|---|---|---|---|---|---|
| | Lap shear | | Extension | Lap shear | | Extension | Lap shear | | Extension |
| Cure | strength | Cohesive | at break | strength | Cohesive | at break | strength | Cohesive | at break |
| Conditions | (MPa) | Failure | (mm) | (MPa) | Failure | (mm) | (MPa) | Failure | (mm) |
| 4 h @ RT | 3.4 | 1/5 | 0.53 | 2.0 | 1/5 | 0.67 | 0.2 | 4/5 | 2.83 |
| 24 h @ RT | — | — | — | 1.8 | 1/5 | 1.16 | 0.1 | 4/5 | 2.42 |
| 4 h @ RT + | 13.8 | 5/5 | 4.48 | 12.9 | 5/5 | 3.70 | 10.0 | 5/5 | 1.25 |
| 160° C. for | | | | | | | | | |
| 30 mins | | | | | | | | | |

¹Ratio of epoxy equivalent to mercaptan equivalent was 1.5:1
²Ratio of epoxy equivalent to mercaptan equivalent was 2:1
³Ratio of epoxy equivalent to mercaptan equivalent was 3:1

The adhesive compositions in Example 3 show the impact the weight ratio of epoxy-containing compound to polythiol curing agent has on the properties of the adhesive composition.

### Example 4

TABLE 4A
Ingredients (g) for Adhesives 8-11 of Example 4

| | | | |
|---|---|---|---|
| Adhe- | Adhe- | Adhe- | Adhe- |
| sive 8 | sive 9 | sive 10 | sive 11 |

Part A

| | | | | |
|---|---|---|---|---|
| Resins | | | | |
| Kane Ace MX-153 | 32.7 | 52 | 32.7 | 52 |
| CAPA di-/MHHPA/Epon 828 | 4.2 | 4.2 | 4.2 | 4.2 |
| (Example A) | | | | |
| CAPA tetra-/MHHPA/Epon | 5 | 5 | 5 | 5 |
| 828 (Example B) | | | | |
| Fillers | | | | |
| DAKOTAPURE 3000 Mica | 1 | 1 | 1 | 1 |
| Calcium Oxide | 1 | 1 | 1 | 1 |
| Aerosil 202 | 0.15 | 0.15 | 0.15 | 0.15 |

Part B

| | | | | |
|---|---|---|---|---|
| Fillers | | | | |
| DAKOTAPURE 3000 Mica | 2 | 2 | 2 | 2 |
| NYAD 400 | 3 | 3 | 3 | 3 |
| Aerosil 202 | 1 | 1 | 1 | 1 |
| Polythiol | | | | |
| THIOCURE PETMP | 9.1 | 9.1 | 9.1 | 9.1 |
| Alkanolamine | | | | |
| TEA | 4 | 4 | 4 | 4 |
| Catalyst | | | | |
| Ajicure PN-40¹⁰ | — | — | 2.5 | 2.5 |
| DABCO | 0.1 | 0.1 | 0.1 | 0.1 |

¹⁰Epoxy-imidazole adduct available from Ajinomoto Fine-Techno Co., Inc.

TABLE 4B
Lap Shear, Cohesive Failure, and Extension at Break Data for Adhesives 8-11 of Example 4

| | Example 8¹ | | | Example 9² | | |
|---|---|---|---|---|---|---|
| | Lap shear | | Extension | Lap shear | | Extension |
| Cure | strength | Cohesive | at break | strength | Cohesive | at break |
| Conditions | (MPa) | failure | (mm) | (MPa) | failure | (mm) |
| 4 h @ RT + | 12.9 | 5/5 | 3.70 | 10.0 | 5/5 | 1.25 |
| 160° C. for | | | | | | |
| 30 mins | | | | | | |

| | Example 10³ | | Example 11⁴ | | |
|---|---|---|---|---|---|
| | | Extension | Lap shear | | Extension |
| Cure | | at break | strength | Cohesive | at break |
| Conditions | Cohesive failure | (mm) | (MPa) | failure | (mm) |
| 4 h @ RT + | 3/5 | 5.78 | 15.9 | 3/5 | 9.95 |
| 160° C. for | | | | | |
| 30 mins | | | | | |

¹Does not include second-step curing catalyst; ratio of epoxy equivalents to mercaptan equivalents was 2:1
²Does not include second-step curing catalyst; ratio of epoxy equivalents to mercaptan equivalents was 3:1
³Includes second-step curing catalyst; ratio of epoxy equivalents to mercaptan equivalents was 2:1
⁴Includes second-step curing catalyst; ratio of epoxy equivalents to mercaptan equivalents was 3:1

The adhesive compositions in Example 4 show the impact a second step curing catalyst and the weight ratio of epoxy-containing compound to polythiol curing agent has on the properties of the adhesive composition.

### Example 5

TABLE 5A
Ingredients (g) for Adhesives 8 and 12 of Example 5

| | |
|---|---|
| Adhesive 8 | Adhesive 12 |

Part A

| | | |
|---|---|---|
| Resins | | |
| Kane Ace MX-153 | 32.7 | 32.7 |
| CAPA di-/MHHPA/Epon 828 | 4.2 | 4.2 |
| (Example A) | | |
| CAPA tetra-/MHHPA/Epon 828 | 5 | 5 |
| (Example B) | | |
| Fillers | | |
| DAKOTAPURE 3000 Mica | 1 | 1 |
| Calcium Oxide | 1 | 1 |
| Aerosil 202 | 0.15 | 0.15 |

Part B

| | | |
|---|---|---|
| Fillers | | |
| DAKOTAPURE 3000 Mica | 2 | 2 |
| NYAD 400 | 3 | 3 |
| Aerosil 202 | 1 | 1 |
| Polythiol | | |
| THIOCURE PETMP | 9.1 | 9.1 |
| Alkanolamine | | |
| TEA | 4 | 4 |
| Catalyst | | |
| DABCO | 0.1 | 0.1 |
| Dyhard ® 100SF¹¹ | — | 1.7 |

¹¹Dicyandiamide commercially available from AlzChem AG

TABLE 5B
Lap Shear, Cohesive Failure, and Extension at
Break Data for Adhesives 8 and 12 of Example 5

| | Adhesive 8¹ | | | Adhesive 12² | |
|---|---|---|---|---|---|
| | Lap shear | | Extension | Lap shear | Extension |
| Cure | strength | Cohesive | at break | strength | at break |
| Conditions | (MPa) | Failure | (mm) | (MPa) | (mm) |
| 4 h @ RT | 2.0 | 1/5 | 0.67 | 1.1 | 0.80 |
| 24 h @ RT | 1.8 | 1/5 | 1.16 | 0.72 | 1.83 |
| 4 h @ RT + | 12.9 | 5/5 | 3.70 | 15.1 | 7.49 |
| 160° C. | | | | | |
| for 30 mins | | | | | |

¹Does not include second-step curing catalyst; weight ratio of epoxy:polythiol was 2:1
²Includes second-step curing catalyst; weight ratio of epoxy:polythiol was 2:1

The adhesive compositions in Example 5 show that the second step curing catalyst improves the full bake properties of the adhesive composition.

### Example 6

The below adhesive compositions and bonds were prepared according to the procedure discussed above with the exception that Wedolit N 22-3 oil was used in place of the Ferrocote 61A oil, and the glass spacer beads were mixed with the adhesive composition instead of being sprinkled over top of the applied adhesive composition.

The adhesive compositions below were tested for lap shear strength according to the procedure described above with the exception that a pull rate of 1.0 mm/min was used instead of 1.3 mm/min.

The adhesive compositions were also tested for wedge impact strength according to ISO 11343. Three specimens were prepared for each test condition. The substrate used was 0.8 mm thick cold rolled steel (CRS) shaped into test coupons as detailed in the ISO method. Adhesive was applied to the raised end of the coupon to an area 20 mm×30 mm. The thickness of the adhesive was maintained with 0.25 mm diameter using glass spacer beads. Bond assemblies were clamped together with spring loaded clips and excess adhesive was removed with a spatula. The test pieces were cured at ambient temperature for two hours then 175° C. for 30 minutes. Bonds were tested using an Instron model CEAST 9350 run at ambient temperature.

TABLE 6A
Ingredients (g) for Adhesives 13-18 of Example 6

| Adhesive | Adhesive | Adhesive | Adhesive | Adhesive | Adhesive |
|---|---|---|---|---|---|
| 13 | 14 | 15 | 16 | 17 | 18 |

Part A

| | | | | | | |
|---|---|---|---|---|---|---|
| Resins | | | | | | |
| Kane Ace MX- | 27 | 27 | 27 | 27 | 27 | 27 |
| 150¹² | | | | | | |
| CAPA di-/ | 4.2 | 4.2 | 4.2 | 4.2 | 4.2 | 4.2 |
| MHHPA/Epon 828 | | | | | | |
| (Example A) | | | | | | |
| CAPA tetra-/ | 5 | 5 | 5 | 5 | 5 | 5 |
| MHHPA/Epon 828 | | | | | | |
| (Example B) | | | | | | |
| Fillers | | | | | | |
| DAKOTAPURE | 1 | 1 | 1 | 1 | 1 | 1 |
| 3000 Mica | | | | | | |
| Calcium Oxide | 1 | 1 | 1 | 1 | 1 | 1 |
| Aerosil 202 | 0.2 | 0.2 | 0.2 | 0.2 | 0.2 | 0.2 |

Part B

| | | | | | | |
|---|---|---|---|---|---|---|
| Fillers | | | | | | |
| DAKOTAPURE | 2 | 2 | 2 | 2 | 2 | 2 |
| 3000 Mica | | | | | | |
| NYAD 400 | 3 | 3 | 3 | 3 | 3 | 3 |
| Aerosil 202 | 1 | 1 | 1 | 1 | 1 | 1 |
| Glass spacer beads | 0.3 | 0.3 | 0.3 | 0.3 | 0.3 | 0.3 |
| (0.25 mm (10 mil)) | | | | | | |
| Polythiol | | | | | | |
| THIOCURE | 9.1 | 9.1 | 9.1 | 9.1 | 9.1 | 9.1 |
| PETMP | | | | | | |
| Amine | | | | | | |
| Diethylene triamine | 0.27 | — | — | — | — | — |
| Ethylenediamine | — | 0.20 | — | — | — | — |
| Alkanolamine | | | | | | |
| Diethanolamine | — | — | 0.40 | — | — | 1.4 |
| N- | — | — | — | 1.0 | — | — |
| methylethanolamine | | | | | | |
| Diisopropanolamine | — | — | — | — | 1.8 | — |
| Catalyst | | | | | | |
| DABCO | 0.1 | 0.1 | 0.1 | 0.1 | 0.1 | 0.1 |

¹²A core-shell poly(butadiene) rubber dispersion (40% rubber by weight) in Epon 828 commercially available from Kaneka Texas Corporation

TABLE 6B
Lap Shear, Cohesive Failure, and Wedge Impact Data for Examples 13-18 of Example 6.

| | Adhesive 13¹ | | | | Adhesive 14² | | | | Adhesive 15³ | | | |
|---|---|---|---|---|---|---|---|---|---|---|---|---|
| | Lap | | | | Lap | | | | Lap | | | |
| | shear | | Wed. | | shear | | Wed. | | shear | | Wed. | |
| Cure | str. | Cohesive | Imp. | Cohesive | str. | Cohesive | Imp. | Cohesive | str. | Cohesive | Imp. | Cohesive |
| Conditions | (MPa) | failure | (N/mm) | Failure | (MPa) | Failure | (N/mm) | Failure | (MPa) | Failure | (N/mm) | Failure |
| 2 h @ RT | 1.1 | — | — | — | 0.8 | — | — | — | 6.0 | — | — | — |
| 2 h @ RT + | 12.5 | 1.8/5 | 9.2 | 1.3/5 | 13.1 | 2/5 | 6.7 | 2.3/5 | 15.0 | 4/5 | 16.5 | 3.2/5 |
| 175° C. for | | | | | | | | | | | | |
| 30 mins | | | | | | | | | | | | |
| | Adhesive 16⁴ | | | | Adhesive 17⁵ | | | | Adhesive 18⁶ | | | |
| | Lap | | | | Lap | | | | Lap | | | |
| | shear | | Wed. | | shear | | Wed. | | shear | | Wed. | |
| Cure | str. | Cohesive | Imp. | Cohesive | str. | Cohesive | Imp. | Cohesive | str. | Cohesive | Imp. | Cohesive |
| Conditions | (MPa) | failure | (N/mm) | Failure | (MPa) | Failure | (N/mm) | Failure | (MPa) | Failure | (N/mm) | Failure |
| 2 h @ RT | 0.5 | — | — | — | 2.4 | — | — | — | 5.4 | — | — | — |
| 2 h @ RT + | 14.7 | 5/5 | 20.3 | 5/5 | 15.6 | 5/5 | 20.3 | 5/5 | 15.0 | 4/5 | 24.1 | 5/5 |
| 175° C. for | | | | | | | | | | | | |
| 30 mins | | | | | | | | | | | | |

¹Comparative, includes triamine
²Comparative, includes diamine
³Includes dialkanolamine
⁴Includes monoalkanolamine
⁵Includes dialkanolamine
⁶Includes dialkanolamine

The adhesive compositions in Example 6 show the improvement in wedge impact and lap shear strength when the compositions include an alkanolamine.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

We claim:

1. An adhesive composition comprising:
a first component; and
a second component that chemically reacts with the first component, the second component comprising:
a polythiol curing agent; and
an alkanolamine.

2. The adhesive composition of claim 1, wherein the first component comprises one or more epoxy-containing compounds.

3. The adhesive composition of claim 1, wherein the first component further comprises core-shell rubber particles.

4. The adhesive composition of claim 1, wherein the polythiol curing agent is present in the second component in an amount sufficient to provide a ratio of epoxide functional groups from the first component to thiol functional groups from the second component of 1.1:1 to 5:1.

5. The adhesive composition of claim 1, wherein the polythiol curing agent comprises pentaerythritol tetra-3-mercaptopropionate.

6. The adhesive composition of claim 1, wherein the weight ratio of polythiol curing agent to alkanolamine is 1:1 to 22:1.

7. The adhesive composition of claim 1, wherein the alkanolamine comprises triethanolamine.

8. The adhesive composition of claim 1, wherein the alkanolamine is present in the second component of the adhesive composition in an amount of at least 0.5% by weight, based on the total weight of the second component.

9. The adhesive composition of claim 1, further comprising a first-step curing catalyst comprising a cyclic tertiary amine.

10. The adhesive composition of claim 1, wherein the adhesive composition further comprises a second-step curing catalyst, wherein the second-step curing catalyst preferably comprises a heat-activated latent curing catalyst.

11. The adhesive composition of claim 1, wherein the adhesive composition is substantially free of a color change indicator, aromatic amine curing catalysts and/or silane.

12. The adhesive composition of claim 1, wherein the adhesive composition cures by a two-step curing process, wherein a first-step comprises that at least a portion of the first component and the second component chemically react when mixed to partially cure the adhesive composition without activation from an external energy source, wherein the second-step comprises application of an external energy source to the adhesive composition to further cure the adhesive composition, wherein the external energy source of the second-step preferably comprises application of an external heat source to heat the adhesive composition to a temperature of at least 110° C. for a period of at least 30 minutes.

13. The adhesive composition of claim 12, wherein the adhesive composition after the first-step has a lap shear of at least 1.0 MPa as measured according to test method ASTM D1002-10 by an Instron model 5567 in tensile mode and/or wherein the adhesive composition after the second-step has a lap shear of at least 5.0 MPa as measured according to test method ASTM D1002-10 by an Instron model 5567 in tensile mode.

14. A method for forming a bond between two substrates comprising:
applying the adhesive composition of claim 1 to a first substrate;
contacting a second substrate to the adhesive composition such that the adhesive composition is located between the first substrate and the second substrate; and
curing the adhesive composition by a two-step curing process.

15. The method of claim 14, wherein the first substrate and second substrate comprise components of an automobile frame.
